(19) United States
(12) Patent Application Publication
(10) Pub. No.: US 2025/0182981 A1
(43) Pub. Date: Jun. 5, 2025

(54) ELECTRONICALLY SWITCHING RAIL-MOUNTED DEVICE AND INSULATING MATERIAL HOUSING

(71) Applicant: Siemens Aktiengesellschaft, München (DE)

(72) Inventors: Alexander Hager, Erlangen (DE); Thomas Lohr, Sinzing (DE); Bernhard Schmid, Burglengenfeld (DE); Sebastian Siegert, Kümmersbruck (DE)

(21) Appl. No.: 18/845,074

(22) PCT Filed: Feb. 17, 2023
(86) PCT No.: PCT/EP2023/054062

§ 371 Date: Sep. 9, 2024

(30) Foreign Application Priority Data
Mar. 8, 2022 (DE) 10 2022 202 311.0

(51) Int. Cl. H01H 9/54; H01H 9/52; H01H 71/02

(52) U.S. Cl. CPC H01H 9/548; H01H 9/52; H01H 71/0207; H01H 2071/0285

(57) ABSTRACT

An electronically switching rail-mounted device for a mounting or top hat rail with an insulating material housing having a front side, a fastening side opposite the front side, and first and second narrow and broad sides connecting the front and securing side. A controller with a power electronics system in a first receiving space formed in the insulating material housing configured to electronically interrupt an electrical line. A cooling unit in a second receiving space formed in the insulating material housing for cooling the power electronics system. The second receiving space having a first boundary surface directly adjacent to the first receiving space and a second boundary surface, different from the first boundary surface, formed by the securing side and/or one of the broad sides. The heat generated by the power electronics system is directly received by the cooling unit and discharged.

The invention relates to an electronically switching rail-mounted device, in particular a low-voltage miniature circuit breaker, for fastening to a mounting rail or top-hat rail, comprising an insulating-material housing having a front side, a fastening side on the opposite side from the front side, and first and second narrow and broad sides connecting the front side and the fastening side. The invention also relates to an insulating-material housing for such an electronically switching rail-mounted device.

Low voltage is used to mean voltages of up to 1000 volts AC or up to 1500 volts DC. Low voltage is used to mean, in particular, voltages which are greater than the extra-low voltage, with values of 50 volts AC or 120 volts DC.

A low-voltage circuit or network or system is used to mean circuits having nominal currents or rated currents of up to 125 amperes, more specifically up to 63 amperes. It is used to mean, in particular, circuits having nominal currents or rated currents of up to 40 amperes, 32 amperes, 25 amperes, 16 amperes or 10 amperes. The current values mentioned are used to mean, in particular, nominal, rated or/and breaking currents, that is to say the maximum current normally carried by the circuit or the current at which the electrical circuit is usually interrupted by a protection device, for example by an electromechanical protective switching device.

Electromechanical protective switching devices—for example circuit breakers, line circuit breakers, fault current circuit breakers and arc fault detection devices—serve to monitor and protect an electrical circuit and are used in particular as switching and safety elements in electrical energy supply and distribution networks. To monitor and protect the electrical circuit, the protective switching device is electrically conductively connected via two or more connection terminals to an electrical line of the circuit to be monitored, in order to interrupt the electric current in the respective monitored line if necessary. To this end, the protective switching device has at least one switching contact, which can be opened if a predefined state occurs—for example if a short circuit or a fault current is detected—in order to separate the monitored circuit from the electrical supply network. Such protective switching devices are also known as rail-mounted devices in the field of low-voltage technology.

Circuit breakers are specifically designed for high currents. A line circuit breaker, which is also referred to as a “miniature circuit breaker” (MCB), represents a so-called overcurrent protection device in electrical installation and is used in particular in the field of low-voltage networks. Circuit breakers and line circuit breakers ensure reliable deactivation in the event of a short circuit and protect consumers and systems from overload, for example from damage to the electrical lines by excessive heating as a result of too high an electric current. They are designed to automatically deactivate a circuit to be monitored in the event of a short circuit or if an overload occurs and thus to separate it from the rest of the supply network. Circuit breakers and line circuit breakers are therefore used in particular as switching and safety elements for monitoring and protecting an electrical circuit in electrical energy supply networks. Line circuit breakers are already known in principle from the documents DE 10 2015 217 704 A1, EP 2 980 822 A1, DE 10 2015 213 375 A1, DE 10 2013 211 539 A1 or EP 2 685 482 B1. A line circuit breaker is generally a safety element that does not automatically reset.

To interrupt a single phase line, use is generally made of a single-pole line circuit breaker which usually has a width of one module (corresponds to about 18 mm). For three-phase connections, use is made (as an alternative to three single-pole switching devices) of three-pole line circuit breakers, which accordingly have a width of three modules (corresponds to about 54 mm). Each of the three phase conductors is in this case assigned a pole, i.e. a switching position. If, in addition to the three phase conductors, the neutral conductor is also intended to be interrupted, reference is made to four-pole devices, which have four switching positions: three for the three phase conductors and one for the common neutral conductor.

In addition, there are compact line circuit breakers, which, with a housing width of only one module, provide two switching contacts for one connection line each, i.e. either for two phase lines (compact line circuit breaker of type 1+1) or for a phase line and the neutral conductor (compact line circuit breaker of type 1+N). Such compact protective switching devices of narrow design are already known in principle for example from the documents DE 10 2004 034 859 A1, EP 1 191 562 B1 or EP 1 473 750 A1.

Arc fault detection devices are used to detect fault arcs as may occur at a defective point of an electrical line—for example a loose cable clamp or on account of a cable breakage. If the fault arc occurs electrically in series with an electrical consumer, the normal operating current is generally not exceeded since it is limited by the consumer. For this reason, the fault arc is not detected by a conventional overcurrent protection device, for example a fuse or a line circuit breaker. In order to determine whether there is a fault arc, both the voltage profile and the current profile are measured over time by the arc fault detection device and are analyzed and evaluated in terms of the profiles characteristic of a fault arc. In the specialist literature, such protection devices for detecting fault arcs are referred to as arc fault detection devices, for short as AFDDs. In North America, the term “arc fault circuit interrupter” (or AFCI) is common.

Line circuit breakers having an electronic interruption unit are relatively new developments. They have a semiconductor-based electronic interruption unit, that is to say the electrical current flow in the low-voltage circuit is carried via semiconductor components or semiconductor switches which can interrupt the electrical current flow or can be switched to be conductive again as required.

Protective switching devices having an electronic interruption unit often have a mechanical isolating contact system, in particular for electrical isolation with isolator properties according to relevant standards for low-voltage circuits. The contacts of the mechanical isolating contact system are connected in series with the electronic interruption unit, that is to say the current of the low-voltage circuit to be protected is carried both via the mechanical isolating contact system and via the electronic interruption unit.

In the case of semiconductor-based protective switching devices or protective devices, solid-state circuit breakers, SSCB for short, the switching energy does not need to be converted into an arc as in the case of a mechanical switching device, but rather needs to be converted into heat by means of an additional circuit, the energy absorber. The breaking energy comprises the energy stored in the circuit, i.e. in the network, line or load impedances. In order to relieve the load on the energy absorber and to protect the electronic components, the heat has to be dissipated as rapidly as possible.

The invention is therefore based on the object of providing an electronically switching rail-mounted device for fastening to a mounting rail or top-hat rail, and an insulating-material housing for such an electronically switching rail-mounted device, by means of which efficient heat dissipation is made possible.

This object is achieved according to the invention by the electronically switching rail-mounted device and the insulating-material housing as claimed in the independent claims. Advantageous configurations of the electronically switching rail-mounted device according to the invention and of the insulating-material housing are the subject of the dependent claims.

The electronically switching rail-mounted device according to the invention for fastening to a mounting rail or top-hat rail comprises an insulating-material housing having a front side, a fastening side on the opposite side from the front side, and first and second narrow and broad sides connecting the front side and the fastening side. Furthermore, the rail-mounted device comprises a control device having a power electronics unit which is received and held in a first receiving space formed in the insulating-material housing and is designed to electronically interrupt an electrical line. The rail-mounted device further comprises a cooling device for cooling the power electronics unit, said cooling device being received and held in a second receiving space formed in the insulating-material housing. The second receiving space has multiple delimiting surfaces, wherein a first delimiting surface directly adjoins the first receiving space and a second delimiting surface, which differs from the first delimiting surface, is formed by the fastening side and/or one of the broad sides of the insulating-material housing.

In the case of the electronically switching rail-mounted device, the flow of current is achieved not by opening a mechanical contact but rather by means of a semiconductor-based power electronics unit, which is arranged, i.e. received and held, in the first receiving space. The heat produced in this case is dissipated with the aid of the cooling device arranged in the second receiving space. In order to ensure the most efficient cooling possible, the first receiving space and the second receiving space are arranged directly adjoining one another in the insulating-material housing, wherein the first delimiting surface forms a—preferably flat—contact surface between the two receiving spaces. In this way, the heat generated by the power electronics unit can be absorbed directly, preferably by heat conduction, by the cooling device. The improved cooling capacity in turn enables a higher switching capacity.

In an advantageous development, the rail-mounted device comprises a first electrical connection module for contact-connection of at least one first external connecting conductor, the first connection module being arranged in a third receiving space formed in the insulating-material housing. Furthermore, the rail-mounted device comprises a second electrical connection module for contact-connection of at least one second external connecting conductor, the second connection module being arranged in a fourth receiving space formed in the insulating-material housing. The third receiving space adjoins the first narrow side and the fourth receiving space adjoins the second narrow side.

By arranging the third and fourth receiving space for the first and, respectively, second electrical connection module for contact-connection of the first and, respectively, second external electrical connecting conductor in a space-saving manner directly on the narrow sides of the insulating-material housing, there is a large, contiguous installation space available for the placing of the remaining components of the electrically switching rail-mounted device. The packaging, that is to say the distribution of the individual assemblies and components of the rail-mounted device within the insulating-material housing, is simplified considerably as a result.

In a further advantageous development, the rail-mounted device comprises a switching mechanism having a manual actuating element arranged on the front side, wherein the switching mechanism is received and held in a fifth receiving space which adjoins the front side and is arranged between the third receiving space and the fourth receiving space.

The switching mechanism has a manual actuating element for manual actuation, i.e. for switching the electronically switching rail-mounted device on and off. In this case, the switching mechanism is arranged in the fifth receiving space which is arranged in the head region, that is to say in the region of the front side of the rail-mounted device, with the result that the rail-mounted device can be easily operated via the manual actuating element arranged on the front side.

In a further advantageous development of the rail-mounted device, the switching mechanism has an electrical tripping unit which is controllable by means of the control device.

The switching mechanism also has a mechanical switching contact, which can be opened for the electrical isolation of the rail-mounted device. The electrical tripping unit serves to control the mechanical switching contact. It is—like the mechanical switching contact—arranged, i.e. received and held, in the fifth receiving space.

In a further advantageous development of the rail-mounted device, the first receiving space and/or the second receiving space are/is arranged between the third receiving space and the fourth receiving space.

When the first electrical connection module is arranged in the third receiving space which directly adjoins the first narrow side and the second electrical connection module is arranged in the fourth receiving space which directly adjoins the second narrow side, it is advantageous in particular in the case of larger, i.e. multi-pole rail-mounted devices, in which the connection modules are provided for the electrical contact-connection of multiple electrical connecting conductors, owing to the structural size of the connection modules, for the first receiving space for the power electronics unit and the second receiving space for the cooling device to be placed, when looking in the direction of the front side, between the third receiving space and the fourth receiving space, in order to thereby achieve a favorable spatial distribution within the insulating-material housing.

In a further advantageous development of the rail-mounted device, the cooling device has a substantially flat main body for thermal contact-connection with the power electronics unit. The flat, planar design of the main body, which forms the physical contact between the cooling device and the power electronics unit, makes it possible to realize good heat transfer by heat conduction from the power electronics unit to the cooling device, resulting in a considerable improvement in the efficiency of the cooling device.

In a further advantageous development of the rail-mounted device, cooling elements for improving the cooling capacity are integrally formed on the main body. The cooling elements, which may for example be in the form of cooling ribs, serve to increase the size of the surface of the cooling device. The higher radiating capacity that can be achieved in this way further increases the efficiency of the cooling device.

In a further advantageous development, the rail-mounted device has a width of one module, wherein, on the fastening side, the second receiving space extends at least partially over the entire width of the rail-mounted device. In the case of so-called single-pole rail-mounted devices which have a width of only one module (this corresponds to about 18 mm), it is advantageous for the second receiving space for receiving the cooling device to be arranged at least partially over the entire width of the rail-mounted device, preferably on the fastening side thereof.

In a further advantageous development, the rail-mounted device has a width of two modules, wherein the second delimiting surface of the second receiving space is formed by one of the two broad sides, wherein the second receiving space has a width of half a module. In the case of so-called two-pole rail-mounted devices which have a width of two modules, it is possible for the second receiving space to be arranged in the form of a disk parallel to one of the two broad sides in the insulating-material housing. Advantageously, the first receiving space, which contains the power electronics unit, is also in the form of a disk and is arranged next to the second receiving space.

In a further advantageous development of the rail-mounted device, the second receiving space extends from the first narrow side to the second narrow side. This makes it possible to use the greatest possible partial surface of the broad side directly adjoining the second receiving space for heat emission.

The insulating-material housing according to the invention for an electronically switching rail-mounted device of the type described above has a front side, a fastening side on the opposite side from the front side, and first and second narrow and broad sides connecting the front side and the fastening side. Furthermore, the insulating-material housing comprises a first receiving space provided and designed to receive the control device, a second receiving space provided and designed to receive the cooling device, a third receiving space provided and designed to receive a first electrical connection module, and a fourth receiving space provided and designed to receive a second electrical connection module. The third receiving space adjoins the first narrow side and the fourth receiving space adjoins the second narrow side.

In an advantageous development, the insulating-material housing comprises a fifth receiving space provided and designed to receive a switching mechanism, wherein the fifth receiving space is arranged between the third receiving space and the fourth receiving space.

In a further advantageous development of the insulating-material housing, the first receiving space and/or the second receiving space are/is arranged between the third receiving space and the fourth receiving space.

In a further advantageous development, the insulating-material housing has a width of one module, wherein, on the fastening side, the second receiving space extends at least partially over the entire width of the rail-mounted device.

In a further advantageous development, the insulating-material housing has a width of two modules, wherein the second receiving space has a width of half a module and is delimited by one of the two broad sides.

In a further advantageous development of the insulating-material housing, the second receiving space extends from the first narrow side to the second narrow side.

With regard to the general advantages of the insulating-material housing according to the invention, reference is made to the statements made above regarding the advantages of the rail-mounted device according to the invention. The division of the available installation space into the different receiving spaces for the power electronics unit, the cooling device, the first and second electrical connection module and the switching mechanism is made possible by the modular design of the rail-mounted device, a predefined installation space of sufficient dimensions with the required interfaces to the components of the rail-mounted device being made available for each of these assemblies. In this way, the design of the rail-mounted device and the arrangement of the individual assemblies and components inside the insulating-material housing are simplified considerably.

Exemplary embodiments of the electronically switching rail-mounted device according to the invention and of the insulating-material housing according to the invention are explained in more detail below with reference to the attached figures. In the figures:

FIG. 1 is a schematic side view of the rail-mounted device according to the invention;

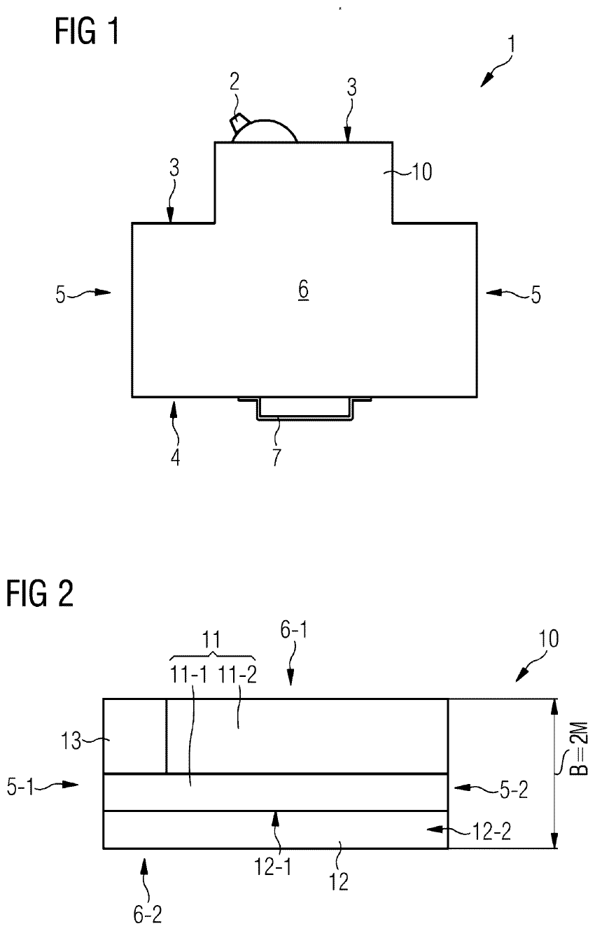

FIGS. 2 to 6 are schematic illustrations of a first exemplary embodiment of the insulating-material housing according to the invention in different views;

FIGS. 7 to 11 are schematic illustrations of a second exemplary embodiment of the insulating-material housing according to the invention in various views;

FIGS. 12 to 15 are schematic illustrations of a third exemplary embodiment of the insulating-material housing according to the invention in various views.

In the various FIGURES of the drawing, identical parts are always provided with the same reference designation. The description applies to all of the drawing figures in which the corresponding part can likewise be seen.

FIG. 1 schematically shows a side view of the electronically switching rail-mounted device 1 according to the invention. The electronically switching rail-mounted device comprises an insulating-material housing 10, a manual actuating element 2 for manual actuation of the rail-mounted device 1 being arranged on the front side 3 of said housing. On a fastening side 4 on the opposite side from the front side 3, the rail-mounted device 1 is able to be fastened to a mounting rail or top-hat rail 7, for example by latching. Front side 3 and fastening side 4 are connected to one another via first and second narrow sides 5 and first and second broad sides 6 of the insulating-material housing 10.

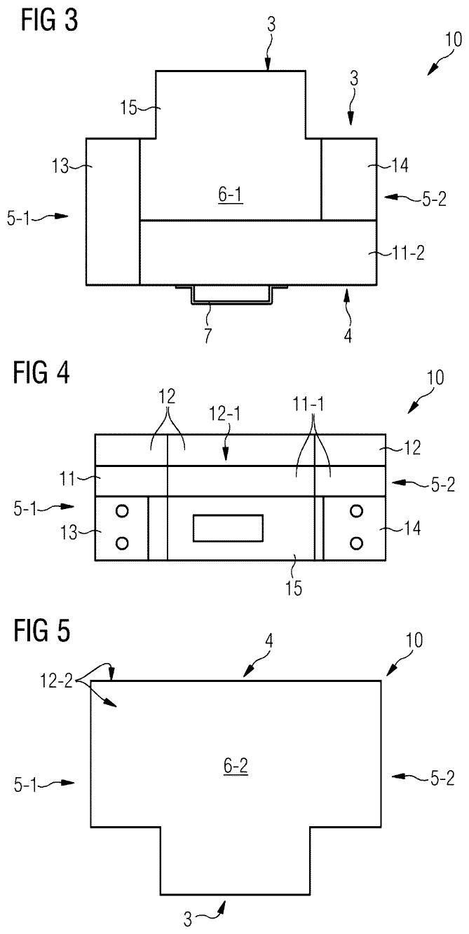

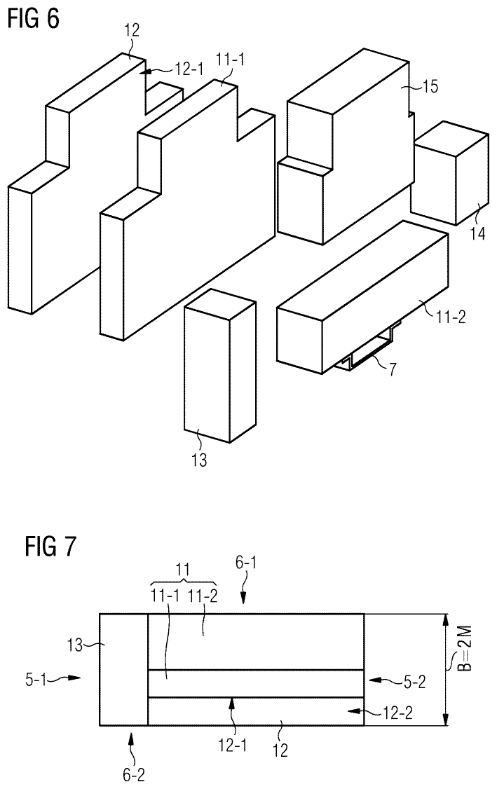

FIGS. 2 to 6 schematically illustrate a first exemplary embodiment of the insulating-material housing 10 according to the invention, which has a width B of two modules M (one module corresponds to about 18 mm), in various views: FIG. 2 shows a view of the fastening side 4, and FIG. 4 shows a view of the front side 3. FIGS. 3 and 5 show views of the two broad sides 6 of the insulating-material housing 10: FIG. 3 shows the first broad side 6-1, and figure 5 shows the second broad side 6-2. The illustrations in FIGS. 2 to 5 are topological illustrations which reflect the spatial arrangement and the positional relationships of the different structural volumes of the insulating-material housing 10. FIG. 6 shows an exploded view, corresponding to FIGS. 2 to 5, of the individual structural volumes of the first exemplary embodiment of the insulating-material housing 10 according to the invention.

The insulating-material housing 10 according to the invention comprises a first receiving space 11 and a second receiving space 12 arranged adjacent thereto. The first receiving space 11 is provided and designed to receive and hold a control device (not illustrated) of the electronically switching rail-mounted device 1, i.e. to fix said control device in the insulating-material housing 10. The control device has a power electronics unit (not illustrated) and is designed to electronically interrupt an electrical connection line of the electronically switching rail-mounted device 1. The second receiving space 12 is provided and designed to receive and hold a cooling device (not illustrated) of the electronically switching rail-mounted device 1.

In this case, the cooling device serves to cool the power electronics unit arranged in the first receiving space 11. In order to ensure the most efficient cooling possible, the second receiving space 12 has a flat first delimiting surface 12-1 which directly adjoins the first receiving space, with the result that the cooling device in the second receiving space 12 can at least partially absorb the quantity of heat generated by the power electronics unit arranged in the first receiving space 11. A second delimiting surface 12-2 of the second receiving space 12, said second delimiting surface differing from the first delimiting surface 12-1, is formed by the fastening side and/or one of the broad sides of the insulating-material housing and serves to at least partially dissipate the quantity of heat absorbed by the cooling device arranged in the second receiving space 12 back to the environment.

In the first exemplary embodiment illustrated in FIGS. 2 to 6, the first receiving space 11 for receiving the control device of the electronically switching rail-mounted device 1 is L-shaped and has a disk-like first subregion 11-1 which is provided and designed to receive the power electronics unit and directly adjoins the first delimiting surface 12-1 of the second receiving space 12. A cuboid second subregion 11-2 of the first receiving space 11, said second subregion adjoining the first subregion 11-1 and being arranged in the region of the fastening side 4, serves to receive further components of the control device which do not belong to the power electronics unit and therefore do not require the additional cooling by the cooling device arranged in the second receiving space 12. This division is, however, not essential to the invention: it is also possible for the components arranged in the second subregion 11-2 to be arranged together with the power electronics unit in the first subregion 11-1, if this permitted by the spatial conditions inside the insulating-material housing 10. Furthermore, the insulating-material housing 10 comprises a third receiving space 13 and a fourth receiving space 14. The third receiving space 13 is arranged directly on the first narrow side 5-1 and is provided and designed to receive and hold a first electrical connection module (not illustrated) of the electrically switching rail-mounted device 1, i.e. to fix said first electrical connection module in the insulating-material housing 10 in a positionally fixed manner. The first electrical connection module constitutes an input connection of the electrically switching rail-mounted device 1 and thus serves for the contact-connection between the rail-mounted device 1 and at least one first external connecting conductor. The fourth receiving space 14 is arranged directly on the second narrow side 5-2 and is provided and designed to receive and hold a second electrical connection module (not illustrated) of the electrically switching rail-mounted device 1. The second electrical connection module correspondingly constitutes an output connection of the electrically switching rail-mounted device 1 and thus serves for the contact-connection between the rail-mounted device 1 and at least one first external connecting conductor. According to the illustration according to FIG. 4, the third receiving space 13 and the fourth receiving space 14 are designed to receive a two-pole first and, respectively, second electrical connection module, that is to say at most two first external connecting conductors can be connected to the first electrical connection module and at most two second external connecting conductors can be connected to the second electrical connection module.

A fifth receiving space 15 of the insulating-material housing 10 is arranged between the third receiving space 13 and the fourth receiving space 14 in the region of the front side 3 and serves to receive and hold a switching mechanism (not illustrated) of the electrically switching rail-mounted device 1. The switching mechanism is mechanically coupled to the manual actuating element 2 and has, for electrical isolation of the rail-mounted device 1 from the power supply, a mechanical switching contact which can be opened and closed, inter alia, by actuation of the manual actuating element 2.

The receiving spaces 11, 12, 13, 14, 15 constitute structural volumes of the insulating-material housing 10 which are provided and designed to receive and hold different assemblies and/or components of the electrically switching rail-mounted device 1. However, this does not necessarily mean that the individual receiving spaces 11, 12, 13, 14, 15 are demarcated entirely from one another by partitions. Rather, the individual structural volumes have defined interfaces to one or more of the other structural volumes, in order to realize the functionality of the electrically switching rail-mounted device 1. For example, it is advantageous for the cooling device to be arranged directly on the power electronics unit, in order to enable efficient cooling by heat conduction. The first delimiting surface 12-1 of the second receiving space 12 then includes the contact surface between the cooling device and the power electronics unit.

In the case of the insulating-material housing 10 which is illustrated in FIGS. 2 to 6 and has a width B of two modules M, the disk-like first subregion 11-1 for receiving the power electronics unit, and the disk-like second receiving space 12 for receiving the cooling device, runs in each case from the first narrow side 5-1 up to the second narrow side 5-2 and from the front side 3 up to the fastening side 4. In this case, both the first subregion 11-1 and the second receiving space 12 have a width of about half a module M. The fifth receiving space 15 for receiving the switching mechanism, and the third receiving space 14 and fourth receiving space 15 for receiving the first and second electrical connection modules, which are arranged in the width direction next to the first subregion 11-1 of the first receiving space, correspondingly has a width of about one module M.

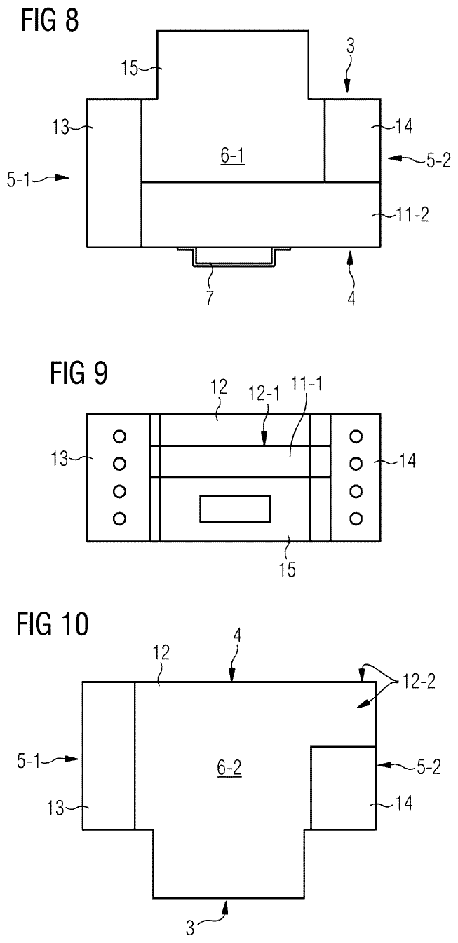

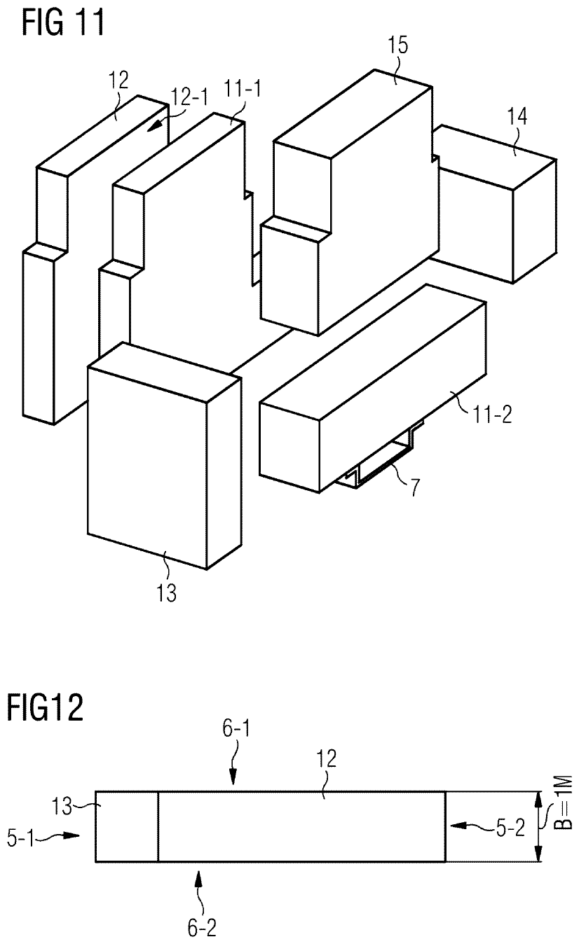

FIGS. 7 to 11 schematically illustrate a second exemplary embodiment of the insulating-material housing 10 according to the invention—likewise having a width B of two modules M—in various views. Correspondingly to the illustrations in FIGS. 2 to 6, FIG. 7 shows a view of the fastening side 4, and FIG. 8 shows a view of the front side 3. FIGS. 9 and 10 show views of the two broad sides 6 of the insulating-material housing 10: FIG. 9 shows the first broad side 6-1, and FIG. 10 shows the second broad side 6-2. The illustrations in FIGS. 7 to 11 are again topological illustrations which reflect the spatial arrangement and the positional relationships of the different structural volumes of the insulating-material housing 10. FIG. 11 shows an exploded view, corresponding to FIGS. 7 to 10, of the individual structural volumes of the second exemplary embodiment of the insulating-material housing 10 according to the invention.

In contrast to the first exemplary embodiment illustrated in FIGS. 2 to 6, in the second exemplary embodiment illustrated in FIGS. 7 to 11 the third receiving space 13 and the fourth receiving space 14 are each designed to receive a four-pole first and, respectively, second electrical connection module, that is to say at most four first external connecting conductors can be connected to the first electrical connection module and at most four second external connecting conductors can be connected to the second electrical connection module. To this end, the third receiving space 13 and the fourth receiving space 14 each have a width of two modules M and each extend from the first broad side 6-1 up to the second broad side 6-2. However, in principle, it is also possible for two-pole first and second electrical connection modules having connection terminals of correspondingly large dimensions to be arranged in the third receiving space 13 and fourth receiving space 14.

Owing to the dimensioning of the third receiving space 13 and of the fourth receiving space 14, there is less installation space available for the first subregion 11-1 of the first receiving space 11 for receiving the power electronics unit and for the second receiving space 12 for receiving the cooling device, for which reason these are then arranged in the longitudinal direction, i.e. from the first narrow side 5-1 to the second narrow side 5-2, between the third receiving space 13 and the fourth receiving space 14 and thus no longer extend over the entire length from the first narrow side 5-1 to the second narrow side 5-2.

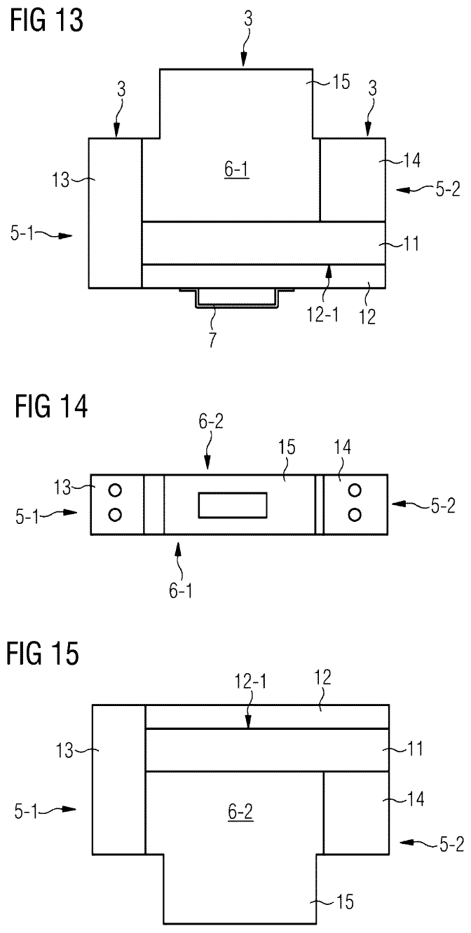

FIGS. 12 to 15 schematically illustrate a third exemplary embodiment of the insulating-material housing 10 according to the invention in various views. Correspondingly to the illustrations in FIGS. 2 to 5 and 7 to 10, FIG. 12 shows a view of the fastening side 4, and FIG. 13 shows a view of the front side 3. FIGS. 14 and 15 show views of the two broad sides 6 of the insulating-material housing 10, FIG. 14 showing the first broad side 6-1 and FIG. 15 showing the second broad side 6-2. The illustrations in FIGS. 12 to 15 are again topological illustrations which reflect the spatial arrangement and the positional relationships of the different structural volumes of the insulating-material housing 10.

In contrast to the first two exemplary embodiments illustrated in the previous FIGS. 2 to 11, the insulating-material housing 10 of the third exemplary embodiment illustrated in FIGS. 12 to 15 has a width B of only one module M. This 50% reduction in the width of the insulating-material housing 10 also changes the spatial arrangement of the receiving spaces 11, 12, 13, 14 and 15 within the insulating-material housing 10.

The first receiving space 11 is again provided and designed to receive and hold the control device of the electronically switching rail-mounted device 1. Similarly, the second is provided and designed to receive and hold the cooling device of the electronically switching rail-mounted device 1.

The second receiving space 12 for receiving the cooling device is in this case arranged directly on the fastening side 4 and extends over the entire inner width of the insulating-material housing 10. The first delimiting surface 12-1 of the second receiving space 12 in turn directly adjoins the first receiving space which is provided and designed to receive the power electronics unit, whereas the second delimiting surface 12-2 of the second receiving space 12, which serves to at least partially dissipate the quantity of heat absorbed by the cooling device arranged in the second receiving space 12 back to the environment, surrounds the second receiving space 12 in a U-shaped manner and is formed by the fastening side 4 and adjoining subregions of the two broad sides 6-1 and 6-2 of the insulating-material housing 10.

Like in the first exemplary embodiment illustrated in FIGS. 2 to 6, the third receiving space 13 is arranged directly on the first narrow side 5-1 and is provided and designed to receive and hold the first electrical connection module of the electrically switching rail-mounted device 1. Like in the first exemplary embodiment illustrated in FIGS. 2 to 6, the fourth receiving space 14 is arranged directly on the second narrow side 5-2 and is provided and designed to receive and hold the second electrical connection module of the electrically switching rail-mounted device 1. However, the fourth receiving space 14 does not extend like the third receiving space 13 from the set-back front side 3 up to the fastening side 4, but rather is kept more compact in terms of its overall height, such that the first receiving space 11 and the second receiving space 12 are still arranged therebelow, i.e. toward the fastening side 4, in the insulating-material housing 10.

The first and the second electrical connection module are of two-pole embodiment according to the schematic illustration in FIG. 14. However, it would also be possible, when using first and second electrical connection modules of correspondingly compact design, for them to be of four-pole design, such that four external connecting conductors—three phase conductors and one neutral conductor—are able to be contact-connected on the input side and on the output side via the first and, respectively, second electrical connection module to the electrically switching rail-mounted device 1.

The fifth receiving space 15 of the insulating-material housing 10 is again arranged between the third receiving space 13 and the fourth receiving space 14 in the region of the front side 3 and serves to receive and hold the switching mechanism (not illustrated) of the electrically switching rail-mounted device 1.

In existing electromechanical protective switching devices, for example a line circuit breaker or fault current circuit breaker, the arrangement of the individual components of the protective switching device is dominated by the mechanics, since these are large-volume components (electromagnetic tripping system, arc quenching chamber, etc.) having correspondingly high space requirements. These protective switching devices are highly integrated, with the result that an exchange of individual components is possible only with a disproportionately high degree of effort. In contrast thereto, this high degree of integration is no longer required in the case of the electrically switching rail-mounted device 1 according to the invention, since these large-volume mechanical components are no longer required there. This makes it possible to construct the rail-mounted device in a structured modular manner, that is to say to arrange the individual components or assemblies in the respectively predefined receiving spaces and to define the respective interfaces to the further assemblies/components. This makes it possible to exchange both the electronic and the mechanical assemblies/components without significant redesign of the rail-mounted device, in order to in this way be able to realize different variants, for example electronics configuration levels.

### LIST OF REFERENCE DESIGNATIONS

1 Rail-mounted device
2 Manual actuating element
3 Front side
4 Fastening side
5 Narrow side
   5-1 First narrow side
   5-2 Second narrow side
6 Broad side
   6-1 First broad side
   6-2 Second broad side
7 Top-hat rail
10 Insulating-material housing
11 First receiving space
   11-1 First subregion
   11-2 Second subregion
12 Second receiving space
   12-1 First delimiting surface
   12-2 Second delimiting surface
13 Third receiving space
14 Fourth receiving space
15 Fifth receiving space
B Width
M Module

1-16 (canceled)

17. An electronically switching rail-mounted device for fastening to a mounting rail or top-hat rail, the electronically switching rail-mounted device comprising:
an insulating-material housing having a front side, a fastening side on an opposite side from said front side, and first and second narrow sides and first and second broad sides connecting said front side and said fastening side;
a controller having a power electronics unit received and held in a first receiving space formed in said insulating-material housing and being configured to electronically interrupt an electrical line;
a cooling device for cooling said power electronics unit, said cooling device being received and held in a second receiving space formed in said insulating-material housing; and
said second receiving space having a plurality of delimiting surfaces, a first delimiting surface directly adjoining said first receiving space and a second delimiting surface, mutually different from said first delimiting surface, being formed by said fastening side and/or one of said broad sides of the insulating-material housing.

18. The electronically switching rail-mounted device according to claim 17, further comprising:
a first electrical connection module, arranged in a third receiving space formed in said insulating-material housing, configured for contact-connection of at least one first external connecting conductor;
a second electrical connection module, arranged in a fourth receiving space formed in said insulating-material housing, configured for contact-connection of at least one second external connecting conductor;
said third receiving space adjoining said first narrow side and said fourth receiving space adjoining said second narrow side.

19. The electronically switching rail-mounted device according to claim 18, further comprising a switching mechanism having a manual actuating element arranged on said front side, said switching mechanism being received and held in a fifth receiving space adjoining said front side and being arranged between said third receiving space and said fourth receiving space.

20. The electronically switching rail-mounted device according to claim 19, wherein said switching mechanism has an electrical tripping unit which is controllable by said controller.

21. The electronically switching rail-mounted device according to claim 18, wherein said first receiving space and/or said second receiving space are arranged between said third receiving space and said fourth receiving space.

22. The electronically switching rail-mounted device according to claim 17, wherein said cooling device has a substantially flat main body for thermal contact-connection with said power electronics unit.

23. The electronically switching rail-mounted device according to claim 22, further comprising cooling elements configured to increase a cooling capacity being integrally formed on said main body.

24. The electronically switching rail-mounted device according to claim 17, further comprising a width of one module, and said second receiving space extending at least in sections over an entire width of the rail-mounted device on said fastening side.

25. The electronically switching rail-mounted device according to claim 17, further comprising a width of two modules, said second delimiting surface of said second receiving space being formed by one of said two broad sides, and said second receiving space having a width of half a module.

26. The electronically switching rail-mounted device according to claim 25, wherein said second receiving space extends from said first narrow side to said second narrow side.

27. An insulating-material housing for an electronically switching rail-mounted device, the insulating-material housing comprising:
a front side, a fastening side on an opposite side from said front side, and first and second narrow sides and first and second broad sides connecting said front side and said fastening side;
a first receiving space configured to receive a controller;
a second receiving space configured to receive a cooling device;
a third receiving space configured to receive a first electrical connection module;
a fourth receiving space configured to receive a second electrical connection module;
said third receiving space adjoining said first narrow side and said fourth receiving space adjoining said second narrow side.

28. The insulating-material housing according to claim 27, further comprising a fifth receiving space configured to receive a switching mechanism, said fifth receiving space being arranged between said third receiving space and said fourth receiving space.

29. The insulating-material housing according to claim 27, wherein said first receiving space and/or said second receiving space are arranged between said third receiving space and said fourth receiving space.

30. The insulating-material housing according to claim 27, further comprising a width of one module, and the second receiving space extending at least in sections over the entire width of the rail-mounted device on the fastening side.

31. The insulating-material housing according to claim 27, further comprising a width of two modules, and the second receiving space having a width of half a module and being delimited by one of the two broad sides.

32. The insulating-material housing according to claim 31, wherein the second receiving space extends from the first narrow side to the second narrow side.
